(19) United States
(12) Patent Application Publication
(10) Pub. No.: US 2020/0247948 A1
(43) Pub. Date: Aug. 6, 2020

(54) POLYKETONE COMPOSITION, POLYKETONE MEMBRANE, SUBSTRATE WITH POLYKETONE MEMBRANE, OPTICAL ELEMENT, IMAGE DISPLAY DEVICE, COVERED MEMBER AND MOLDED ARTICLE

(71) Applicant: HITACHI CHEMICAL COMPANY, LTD., Tokyo (JP)

(72) Inventors: Hiroshi MATSUTANI, Chiyoda-ku, Tokyo (JP); Naoki FURUKAWA, Chiyoda-ku, Tokyo (JP); Yohei ISHIKAWA, Chiyoda-ku, Tokyo (JP); Masahiro MATSUNAGA, Chiyoda-ku, Tokyo (JP)

(21) Appl. No.: 16/481,945

(22) PCT Filed: Jan. 15, 2018
(86) PCT No.: PCT/JP2018/000881

§ 371 Date: Jul. 30, 2019

(30) Foreign Application Priority Data
Jan. 31, 2017 (JP) 2017-015424

(51) Int. Cl. C08G 67/00; C09D 173/00; C08K 3/36

(52) U.S. Cl. CPC C08G 67/00; C09D 173/00; G02F 1/133528; C08G 2150/00; C08K 3/36

(57) ABSTRACT

A polyketone composition contains: a polyketone containing a structural unit represented by the following Formula (I), and inorganic particles; in which a content of the inorganic particle is from 10 parts by mass to 70 parts by mass, based on 100 parts by mass of a total amount of the polyketone and the inorganic particles, and an average particle diameter of the inorganic particles is from 10 nm to 200 nm. In Formula (I), each X independently represents a bivalent group that has from 1 to 50 carbon atoms and that may have a substituent group, each Y independently represents a bivalent hydrocarbon group that has from 1 to 30 carbon atoms and that may have a substituent group, and n represents an integer from 1 to 1,500

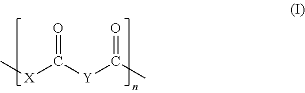

### TECHNICAL FIELD

The present invention relates to a polyketone composition, a polyketone membrane, a substrate with a polyketone membrane, an optical element, an image display device, a covered member and a molded article.

### BACKGROUND ART

Aromatic polyketones having aromatic rings and carbonyl groups in the main chain have excellent heat resistance and mechanical properties and are used as engineering plastics. Most polymers belonging to aromatic polyketones are aromatic polyether ketones polymerized by utilizing a nucleophilic aromatic substitution reaction, which also have an ether bond in the main chain. On the other hand, it is known that aromatic polyketones having no ether bond in the main chain can exhibit even more excellent heat resistance and chemical resistance than those of aromatic polyether ketones (see, for example, Patent Document 1 and Patent Document 2).

In recent years, it has been reported that an aromatic polyketone with high transparency and heat resistance can be obtained by directly polymerizing an alicyclic dicarboxylic acid and 2,2′-dialkoxybiphenyl compound by Friedel-Crafts acylation (see, for example, Patent Document 3), and application thereof to optical members is expected.

In a case in which a resin material such as an aromatic polyketone is applied to optical members, it is preferable that properties that inorganic materials can not exhibit exerts. Examples of such properties include lightness and flexibility compared to inorganic materials. Examples of the application of the resin material include a coating material and a glass substitute material focusing the property of light weight, and a flexible display focusing the property of flexibility. In particular, realization of application to flexible displays has attracted particular attention in recent years.

### RELATED ART DOCUMENT

### Patent Document

Patent Document 1: Japanese Patent Application Laid-Open (JP-A) No. 62-7730

Patent Document 2: JP-A No. 2005-272728

Patent Document 3: JP-A No. 2013-53194

### SUMMARY OF INVENTION

### Technical Problem

Materials for flexible displays and the like are demanded to have not only high transparency and heat resistance, but also high surface hardness and low coefficient of thermal expansion. Membranes formed from the aromatic polyketones in the Documents described above are excellent in transparency and heat resistance, but have room for improvement in surface hardness and coefficient of thermal expansion.

The present invention has been made in view of the above circumstances, and an object thereof is to provide a polyketone composition such that a membrane formed therefrom exhibits high surface hardness and a low coefficient of thermal expansion while maintaining transparency and heat resistance, as well as a polyketone membrane, a substrate with a polyketone membrane, an optical element, an image display device, a covered member and a molded article.

### Solution to Problem

The present invention includes the following embodiments.
<1> A polyketone composition containing:

a polyketone containing a structural unit represented by the following Formula (I); and

inorganic particles,

wherein a content of the inorganic particle is from 10 parts by mass to 70 parts by mass, based on 100 parts by mass of a total amount of the polyketone and the inorganic particles, and an average particle diameter of the inorganic particles is from 10 nm to 200 nm:

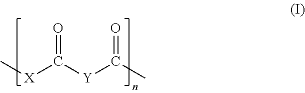

in which, in Formula (I), each X independently represents a bivalent group that has from 1 to 50 carbon atoms and that may have a substituent group, each Y independently represents a bivalent hydrocarbon group that has from 1 to 30 carbon atoms and that may have a substituent group, and n represents an integer from 1 to 1,500.
<2> The polyketone composition according to <1>, in which, in a case in which the polyketone composition configures a membrane having a thickness of 10 μm, haze is less than 1%.
<3>0 The polyketone composition according to <1> or <2>, in which, in a case in which the polyketone composition configures a membrane, a transmittance of visible light with a wavelength of 400 nm is 85% or more in terms of a 1₁.tm film thickness equivalent.
<4> The polyketone composition according to any one of <1> to <3>, in which each X independently contains a bivalent group that has from 6 to 50 carbon atoms and that has an aromatic ring.
<5> The polyketone composition according to any one of <1> to <4>, in which each X independently contains at least one selected from the group consisting of the following Formulae (II-1) to (II-3):

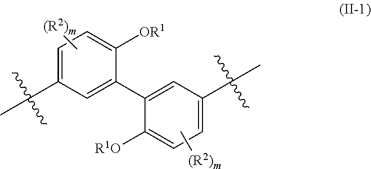

in which, in Formula (II-1), each R¹ independently represents a hydrogen atom or a hydrocarbon group that has from 1 to 30 carbon atoms and that may have a substituent group, each R² independently represents a hydrocarbon group that has from 1 to 30 carbon atoms and that may have a substituent, and each m independently represents an integer from 0 to 3,

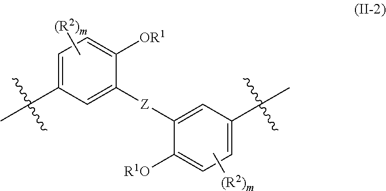

in which, in Formula (II-2), each R¹ independently represents a hydrogen atom or a hydrocarbon group that has from 1 to 30 carbon atoms and that may have a substituent group, each R² independently represents a hydrocarbon group that has from 1 to 30 carbon atoms and that may have a substituent group, each m independently represents an integer from 0 to 3, and Z represents an oxygen atom or a bivalent group represented by the following formulae (III-1) to (III-7):

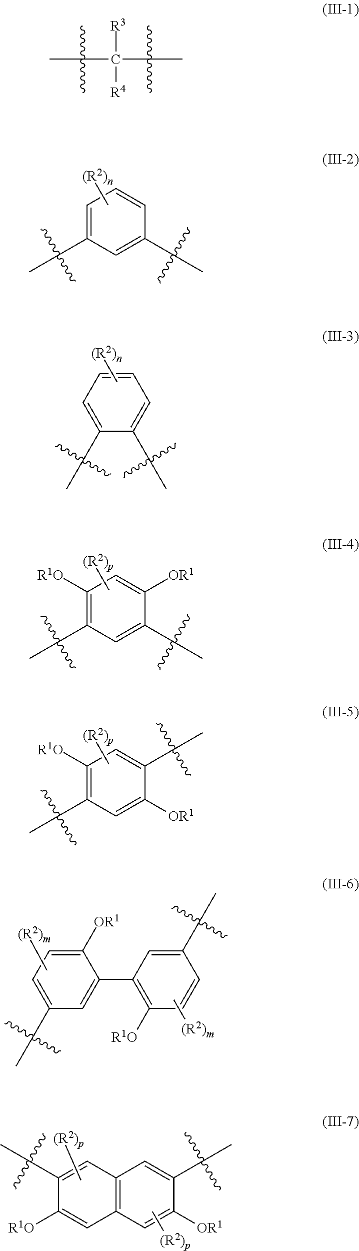

in which, in Formulae (III-1) to (III-7), each R¹ independently represents a hydrogen atom or a hydrocarbon group that has from 1 to 30 carbon atoms and that may have a substituent group, each R² independently represents a hydrocarbon group that has from 1 to 30 carbon atoms and that may have a substituent group, each of R³ and R⁴ independently represents a hydrogen atom or a hydrocarbon group that has from 1 to 30 carbon atoms and that may have a substituent group, each m independently represents an integer from 0 to 3, each n independently represents an integer from 0 to 4, and each p independently represents an integer from 0 to 2, and

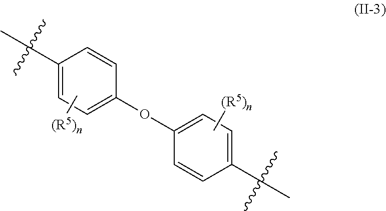

in which, in Formula (II-3), each R⁵ represents a hydrocarbon group that has from 1 to 30 carbon atoms and that may have a substituent, and each n independently represents an integer from 0 to 4.
<6> The polyketone composition according to any one of <1> to <5>, in which, in Formula (I), Y contains a bivalent saturated hydrocarbon group.
<7> The polyketone composition according to <6>, in which, in Formula (I), Y contains a bivalent saturated alicyclic hydrocarbon group.
<8> The polyketone composition according to any one of <1> to <7>, in which, in Formula (I), Y has from 6 to 30 carbon atoms.
<9> The polyketone composition according to any one of <1> to <8>, in which the inorganic particles are silica particles.
<10> The polyketone composition according to any one of <1> to <9>, further containing a solvent.
<11> A polyketone membrane that is formed from the polyketone composition according to any one of <1> to <10>.
<12> A substrate with a polyketone membrane, containing:

a substrate; and

a polyketone membrane according to <11>, that is provided on or above at least one portion of a surface of the substrate.
<13> An optical element containing the polyketone membrane according to <11> or the substrate with a polyketone membrane according to <12>.
<14> An image display device containing the polyketone membrane according to <11> or the substrate with a polyketone membrane according to <12>.
<15> A covered member containing:

a member; and

a covering membrane that is formed from the polyketone composition according to any one of <1> to <10>, and that is provided on or above at least one portion of a surface of the member.

<16> A molded article that is formed from the polyketone composition according to any one of <1> to <10>.

### Advantageous Effects of Invention

According to the present invention, a polyketone composition such that a membrane formed therefrom exhibits high surface hardness and a low coefficient of thermal expansion while maintaining transparency and heat resistance, as well as a polyketone membrane, a substrate with a polyketone membrane, an optical element, an image display device, a coved member and a molded article can be provided.

### DESCRIPTION OF EMBODIMENTS

Hereinafter, the present invention will be described in detail. However, the present invention is not limited to the following embodiments. In the following embodiments, the constituent elements (including the element processes and the like) are not indispensable except when particularly explicitly mentioned. The same applies to numerical values and ranges thereof, in which numerical values and ranges thereof do not limit the present invention.

In the present disclosures, each numerical range specified using “(from) . . . to . . . ” represents a range including the numerical values noted before and after “to” as the minimum value and the maximum value, respectively.

In the present disclosures, regarding numerical ranges stated hierarchically herein, the upper limit or the lower limit of a numerical range of a hierarchical level may be replaced with the upper limit or the lower limit of a numerical range of another hierarchical level. Further, in the present disclosures, regarding a numerical range, the upper limit or the lower limit of the numerical range may be replaced with a relevant value shown in any of Examples.

In the present disclosures, regarding a content of a component in a composition, in a case in which plural kinds of substances exist corresponding to a component in the composition, the content means, unless otherwise specified, the total amount of the plural kinds of substances existing in the composition.

In the present disclosures, the term “layer” or “membrane” comprehends herein not only a case in which the layer or the membrane is formed over the whole observed region where the layer or the membrane is present, but also a case in which the layer or the membrane is formed only on part of the region.

In the present disclosures, the term “layered” as used herein indicates “provided on or above”, in which two or more layers may be bonded or detachable.

In the present disclosures, the term “average particle diameter” is, unless otherwise specified, used for the same meaning as the term “average primary particle diameter”.

In the present disclosures, the term “excellent transparency” means that the visible light transmittance (transmittance of visible light with a wavelength of 400 nm) is 80% or more (in terms of film thickness of 1 μm).

In the present disclosures, the term “heat resistant” means that a member containing a polyketone has a glass transition temperature (Tg) of 180° C. or higher.

In the present disclosures, the term “high surface hardness” means that a pencil hardness of a formed membrane is 2H or more.

In the present disclosures, the term “low coefficient of thermal expansion” means that a coefficient of thermal expansion of a formed membrane is 50 ppm/° C. or lower.

<Polyketone Composition>

A polyketone composition in the present embodiment contains; a polyketone containing a structural unit represented by the following Formula (I) (hereinafter, also referred to as “specific polyketone”); and inorganic particles, in which a content of the inorganic particles is from 10 parts by mass to 70 parts by mass, based on 100 parts by mass of a total amount of the polyketone and the inorganic particles, and an average particle diameter of the inorganic particles is from 10 nm to 200 nm.

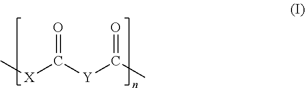

In Formula (I), each X independently represents a bivalent group that has from 1 to 50 carbon atoms and that may have a substituent group, each Y independently represents a bivalent hydrocarbon group that has from 1 to 30 carbon atoms and that may have a substituent group, and n represents an integer from 1 to 1,500.

The polyketone composition in the present embodiment has the constitution described above, whereby a membrane formed therefrom exhibits a high surface hardness and a low coefficient of thermal expansion while maintaining transparency and heat resistance. The reason for that is unclear but can be assumed as follows.

A specific polyketone includes a carbonyl group, and thus is excellent in heat resistance and transparency. A content of the inorganic particle is from 10 parts by mass to 70 parts by mass, based on 100 parts by mass of a total amount of the specific polyketone and the inorganic particle and an average particle diameter of the inorganic particles is from 10 nm to 200 nm, thereby allowing a high surface hardness and a low coefficient of thermal expansion to be achieved with transparency of a membrane being maintained.

The specific polyketone is almost formed from a C—C bond, and thus also has the advantage of having a molecular chain by itself excellent in stability to chemicals.

Hereinafter, each component will be explained.

(Polyketone)

The polyketone composition contains a specific polyketone. The specific polyketone includes a structure unit represented by the following Formula (I).

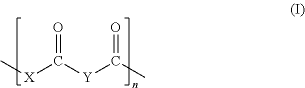

In Formula (I), each X independently represents a bivalent group that has from 1 to 50 carbon atoms and that may have a substituent group. Each Y independently represents a bivalent hydrocarbon group that has from 1 to 30 carbon atoms and that may have a substituent group. n represents an integer from 1 to 1,500, preferably 2 to 1,000, and more preferably 5 to 500. In a case in which the bivalent group or the hydrocarbon group has the substituent, the term “a number of carbon atoms” of the bivalent group or the hydrocarbon group means a number which does not include a number of carbon atoms of the substituent, and the same applies below.

The bivalent group represented by X has from 1 to 50 carbon atoms, preferably from 1 to 30 carbon atoms, and more preferably from 1 to 24 carbon atoms.

A substituent that X may have is not particularly limited, and examples of the substituent include a halogen atom, an alkoxy group having from 1 to 5 carbon atoms, and an acyl group having from 2 to 5 carbon atoms.

The bivalent group represented by X is preferably hydrocarbon group, and more preferably a hydrocarbon group having an aromatic ring. In a case in which X is a hydrocarbon group having an aromatic ring, a heat resistance tends to be further improved.

From the viewpoint of improving a heat resistance, X is preferably a bivalent group that has from 6 to 50 carbon atoms and that has an aromatic ring. Examples of the aromatic ring include a benzene ring, a naphthalene ring, an anthracene ring, a phenanthrene ring, a naphthacene ring, a chrysene ring, a pyrene ring, a triphenylene ring, a pentacene ring, and a benzopyrene ring.

Further, X more preferably includes a plurality of aromatic rings, and the plurality of aromatic rings are non-conjugated with each other, or have weak conjugate relationship with each other (hereinafter, also referred to as “specific aromatic ring group”). This can realize favorable diacylation at a low reaction temperature during synthesis of polyketone, resulting in polyketone having high molecular weight and excellent heat resistance. The specific aromatic ring group preferably has from 12 to 50 carbon atoms.

Here, the term “a plurality of aromatic rings are non-conjugated with each other or have weak mutual conjugate relationship” means that two aromatic rings are bonded via an ether bond or a methylene bond, or conjugation between aromatic rings is suppressed by steric hindrance by a substituent such as 2,2′-substituted biphenyl.

Examples of X include divalent groups represented by the following Formulae (II-1) to (II-3).

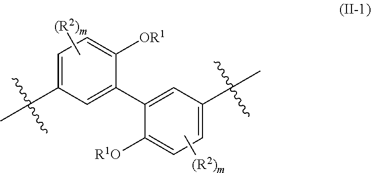

In Formula (II-1), each R¹ independently represents a hydrogen atom or a hydrocarbon group that has from 1 to 30 carbon atoms and that may have a substituent group, each R² independently represents a hydrocarbon group that has from 1 to 30 carbon atoms and that may have a substituent, and each m independently represents an integer from 0 to 3. A wavy line means a bonding portion, and the same applies below.

From the viewpoint of improving a heat resistance, the hydrocarbon group represented by R¹ has from 1 to 30 carbon atoms, preferably from 1 to 10 carbon atoms, and more preferably from 1 to 6 carbon atoms.

Examples of the hydrocarbon group represented by R¹ include a saturated aliphatic hydrocarbon group, an unsaturated aliphatic hydrocarbon group, and an alicyclic hydrocarbon group.

Examples of the saturated aliphatic hydrocarbon group represented by R¹ include a methyl group, an ethyl group, a n-propyl group, an isopropyl group, an n-butyl group, an isobutyl group, a sec-butyl group, a t-butyl group, an n-pentyl group, an isopentyl group, a sec-pentyl group, a neo-pentyl group, a t-pentyl group, an n-hexyl group, an n-heptyl group, an n-octyl group, an n-nonyl group, an n-decyl group, an n-eicosanyl group, and an n-triacontanyl group. Examples of the saturated aliphatic hydrocarbon group may also include those in which the below-described alicyclic hydrocarbon group has been introduced at a terminal portion of the saturated aliphatic hydrocarbon group.

Examples of the unsaturated aliphatic hydrocarbon group represented by R¹ include: an alkenyl group such as a vinyl group or an allyl group; and an alkynyl group such as an ethynyl group. Examples of the unsaturated aliphatic hydrocarbon group may also include those in which the below-described alicyclic hydrocarbon group is introduced into a terminal portion of the unsaturated aliphatic hydrocarbon group.

Examples of the alicyclic hydrocarbon group represented by R¹ include: a cycloalkyl group such as a cyclohexyl group, a cycloheptyl group, a cyclooctyl group and a norbornyl group; and a cycloalkenyl group such as a cyclohexenyl group. The alicyclic hydrocarbon group may also include those in which the alicyclic has at least one selected from the group consisting of saturated aliphatic hydrocarbon group and unsaturated aliphatic hydrocarbon group into the alicyclic portion.

A substituent that the hydrocarbon group represented by X may have is not particularly limited, and examples of the substituent include a halogen atom, an alkoxy group having from 1 to 5 carbon atoms, and an acyl group having from 2 to 5 carbon atoms.

In Formula (II-1), each R² independently represents a hydrocarbon group that has from 1 to 30 carbon atoms and that may have a substituent. From the viewpoint of heat resistance, the hydrocarbon group represented by R² has from 1 to 10 carbon atoms, and more preferably from 1 to 5 carbon atoms.

Examples of such a hydrocarbon group having from 1 to 30 carbon atoms represented by R² include the same as the hydrocarbon group having from 1 to 30 carbon atoms exemplified for R′. Examples of substituents that the hydrocarbon group represented by R² may have include a halogen atom, an alkoxy group having from 1 to 5 carbon atoms, and an acyl group having from 2 to 5 carbon atoms.

In Formula (II-1), each m independently represents an integer from 0 to 3, preferably an integer from 0 to 2, and more preferably 0 or 1.

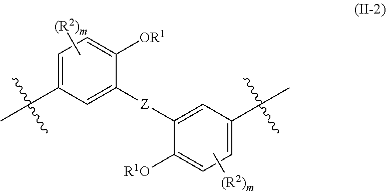

In Formula (II-2), each Rⁱ independently represents a hydrogen atom or a hydrocarbon group that has from 1 to 30 carbon atoms and that may have a substituent group, each R² independently represents a hydrocarbon group that has from 1 to 30 carbon atoms and that may have a substituent group, each m independently represents an integer from 0 to 3, and Z represents an oxygen atom or a bivalent group represented by the following formulae (III-1) to (III-7).

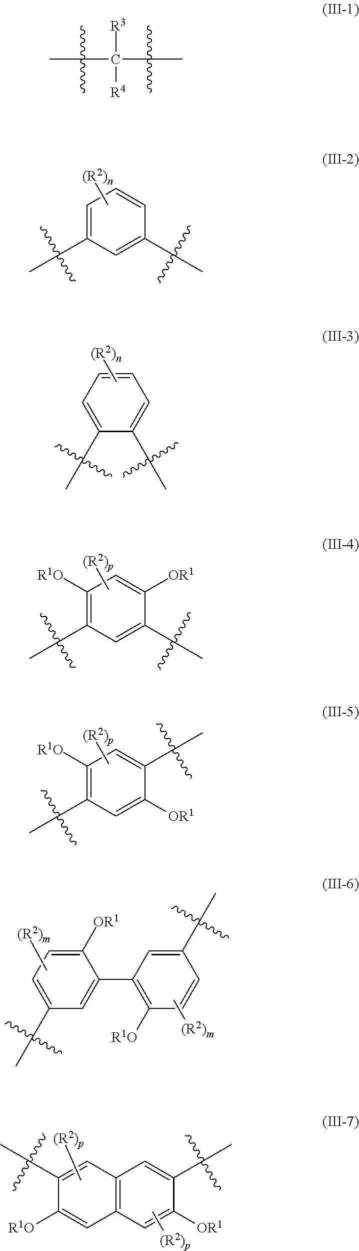

In Formulae (III-1) to (III-7), each Rⁱ independently represents a hydrogen atom or a hydrocarbon group that has from 1 to 30 carbon atoms and that may have a substituent group, each R² independently represents a hydrocarbon group that has from 1 to 30 carbon atoms and that may have a substituent group, each of R³ and R⁴ independently represents a hydrogen atom or a hydrocarbon group that has from 1 to 30 carbon atoms and that may have a substituent group, each m independently represents an integer from 0 to 3, each n independently represents an integer from 0 to 4, and each p independently represents an integer from 0 to 2.

From the viewpoint of heat resistance, each of R³ and R⁴ in Formula (III-1) is preferably hydrocarbon groups that has from 1 to 5 carbon atoms and that may have a substituent. Examples of the hydrocarbon group having from 1 to 30 carbon atoms represented by R³ and R⁴ include the same as the hydrocarbon groups having from 1 to 30 carbon atoms exemplified for R¹ in Formula (II-1). Examples of substituents that R³ and R⁴ may have include a halogen atom, an alkoxy group having from 1 to 5 carbon atoms, and an acyl group having from 2 to 5 carbon atoms.

Each n in Formulae (III-2) and (III-3) independently represents an integer from 0 to 4, preferably an integer from 0 to 2, and more preferably 0 or 1.

Each p in Formulae (III-4), (III-5) and (III-7) independently represents an integer from 0 to 2, and preferably 0 or 1.

Details of each of R¹, R², and m in Formula (II-2) are the same as R¹, R² and m in Formula (II-1).

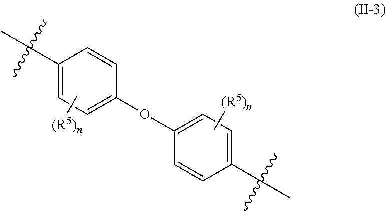

In Formula (II-3), each R⁵ represents a hydrocarbon group that has from 1 to 30 carbon atoms and that may have a substituent, and each n independently represents an integer from 0 to 4.

From the viewpoint of heat resistance, the hydrocarbon group represented by R⁵ has preferably from 1 to 10 carbon atoms, and more preferably from 1 to 5 carbon atoms.

Examples of the hydrocarbon group having from 1 to 30 carbon atoms represented by R⁵ include the same as the hydrocarbon group having from 1 to 30 carbon atoms exemplified for R¹ in Formulae (II-1). Examples of the substituent that R⁵ may have include a halogen atom, an alkoxy group having from 1 to 5 carbon atoms, and an acyl group having from 2 to 5 carbon atoms.

In Formula (II-3), each n independently represents an integer from 0 to 4, preferably an integer from 1 to 4, more preferably an integer from 1 to 3, and even more preferably 1 or 2.

In Formula (I), each Y independently represents a bivalent hydrocarbon group that has from 1 to 30 carbon atoms and that may have a substituent. The hydrocarbon group represented by Y has from 1 to 30 carbon atoms, preferably from 4 to 30 carbon atoms, and from the viewpoint of heat resistance, more preferably from 6 to 30 carbon atoms.

The hydrocarbon group represented by Y preferably contains a saturated hydrocarbon group from the viewpoint of transparency. The saturated hydrocarbon group may be a saturated aliphatic hydrocarbon group or a saturated alicyclic hydrocarbon group. From the viewpoint of achieving both of higher heat resistance and transparency, the hydrocarbon group represented by Y preferably contains a saturated alicyclic hydrocarbon group. Because the alicyclic hydrocarbon group is bulkier than the aliphatic hydrocarbon group in a case in which the number of carbon atoms is same, the alicyclic hydrocarbon group tends to be excellent in solubility into a nitrogen-containing compound and into a solvent, while maintaining high heat resistance and transparency.

The hydrocarbon group represented by Y may include a plurality of saturated aliphatic hydrocarbon groups, or a plurality of saturated alicyclic hydrocarbon groups. Y may include a saturated aliphatic hydrocarbon group and a saturated alicyclic hydrocarbon group in combination.

The saturated aliphatic hydrocarbon group represented by Y preferably has from 1 to 30 carbon atoms, and more preferably from 3 to 30.

Examples of the saturated aliphatic hydrocarbon group include a methylene group, an ethylene group, a trimethylene group, a methylethylene group, a tetramethylene group, a 1-methyltrimethylene group, a 2-methyltrimethylene group, an ethylethylene group, a 1,1-dimethylethylene group, 1,2-dimethylethylene group, a pentylene group, a 1-methyltetramethylene group, a 2-methyltetramethylene group, a 1-ethyltrimethylene group, a 2-ethyltrimethylene group, a 1,1-dimethyltrimethylene group, a 2,2-dimethyltrimethylene group, a 1,2-dimethyltrimethylene group, a propyl ethylene group, an ethylmethylethylene group, a hexylene group, a 1-methylpentylene group, a 2-methylpentylene group, a 3-methylpentylene group, a 1-ethyltetramethylene group, a 2-ethyltetramethylene group, a 1-propyltrimethylene group, a 2-propyltrimethylene group, a butylethylene group, a 1,1-dimethyltetramethylene group, a 2,2-dimethyltetramethylene group, a 1,2-dimethyltetramethylene group, a 1,3-dimethyltetramethylene group, a 1,4-dimethyltetramethylene group, a 1,2,3-trimethyltrimethylene group, a 1,1,2-trimethyltrimethylene group, a 1,1,3-trimethyltrimethylene group, a 1,2,2-trimethyltrimethylene group, a 1-ethyl-l-methyltrimethylene group, a 2-ethyl-2-methyltrimethylene group, a 1-ethyl-2-methyltrimethylene group, a 2-ethyl-l-methyltrimethylene group, a 2,2-ethylmethyltrimethylene group, a heptylene group, an octylene group, a nonylene group, a decylene group, an icosanylene group, and a triacontylene group.

From the viewpoint of heat resistance, preferable examples of the saturated aliphatic hydrocarbon group include at least one selected from the group consisting of a hexylene group, a methylpentylene group, an ethyltetramethylene group, a propyltrimethylene group, a butylethylene group, a dimethyltetramethylene group, a trimethyltrimethylene group, an ethylmethyltrimethylene group, a heptylene group, an octylene group, a nonylene group, a decylene group, an icosanylene group, and a triacontylene group.

The saturated alicyclic hydrocarbon group represented by Y preferably has from 3 to 30 carbon atoms, more preferably from 4 to 30 carbon atoms, and even more preferably from 6 to 30 carbon atoms.

Preferable examples of the saturated alicyclic hydrocarbon group include a divalent group containing a cyclopropane structure, a cyclobutane structure, a cyclopentane structure, a cyclohexane structure, a cycloheptane structure, a cyclooctane structure, a cuban structure, a norbornane structure, a tricyclo [5.2.1.0] decane structure, an adamantane structure, a diadamantane structure, a bicyclo [2.2.2] octane structure, and a decahydronaphthalene structure.

From the viewpoint of heat resistance, preferable examples of the saturated alicyclic hydrocarbon group include at least one divalent group containing a structure selected from the group consisting of a cyclohexane structure, a cycloheptane structure, a cyclooctane structure, a cuban structure, a norbornane structure, a tricyclo [5.2.1.0] decane structure, an adamantane structure, a diadamantane structure, a bicyclo [2.2.2] octane structure, and a decahydronaphthalene structure.

Examples of substituents that the hydrocarbon group represented by Y may have include an amino group, an oxo group, a hydroxyl group, and a halogen atom.

Y preferably includes at least one bivalent group selected from the group consisting of the following Formula (IV), and Formulae (V-1) to (V-3), and more preferably includes at least one bivalent hydrocarbon group represented by Formula (IV).

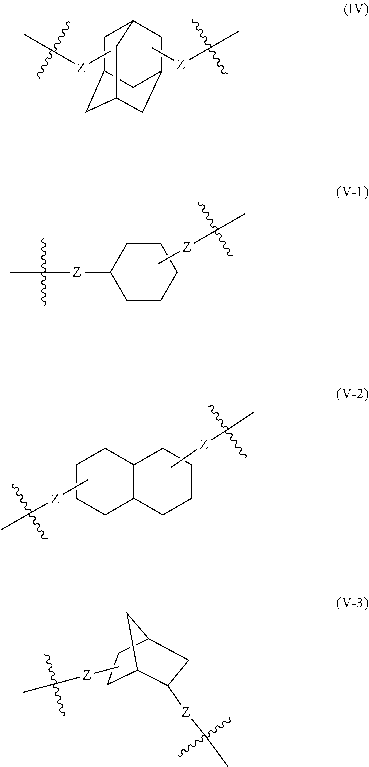

Hydrogen atom(s) of the adamantane structure in Formula (IV), hydrogen atom(s) of the cyclohexane structure in Formula (V-1), hydrogen atom(s) of the decalin structure in Formula (V-2), and hydrogen atom(s) of the norbornane structure in Formula (V-3) may be substituted with a hydrocarbon group, an amino group, an oxo group, a hydroxyl group, or a halogen atom. Each Z in Formula (IV), (V-1), (V-2) and (V-3) independently represents single bond or a bivalent saturated hydrocarbon group that has from 1 to 10 carbon atoms and that may have a substituent.

From the viewpoint of obtaining a flexible membrane, each Z is preferably a bivalent saturated hydrocarbon group that has from 1 to 10 carbon atoms and that may have a substituent group, and from the viewpoint of heat resistance, Z is preferably a bivalent saturated hydrocarbon group having from 1 to 5 carbon atoms.

Examples of the bivalent saturated hydrocarbon group represented by Z include a methylene group, an ethylene group, a trimethylene group, a methylethylene group, a tetramethylene group, a 1-methyltrimethylene group, a 2-methyltrimethylene group, an ethylethylene group, a 1,1-dimethylethylene group, a 1,2-dimethylethylene group, a pentylene group, a 1-methyltetramethylene group, a 2-methyltetramethylene group, a 1-ethyltrimethylene group, a 2-ethyltrimethylene group, a 1,1-dimethyltrimethylene group, a 2,2-dimethyltrimethylene group, a 1,2-dimethyltrimethylene group, a propylethylene group, an ethylmethylethylene group, a hexylene group, a 1-methylpentylene group, a 2-methylpentylene group, a 3-methylpentylene group, a 1-ethyltetramethylene group, a 2-ethyltetramethylene group, a 1-propyltrimethylene group, a 2-propyltrimethylene group, a butylethylene group, a 1,1-dimethyltetramethylene group, a 2,2-dimethyltetramethylene group, a 1,2-dimethyltetramethylene group, a 1,3-dimethyltetramethylene group, a 1,4-dimethyltetramethylene group, a 1,2,3-trimethyltrimethylene group, a 1,1,2-trimethyltrimethylene group, a 1,1,3-trimethyltrimethylene group, a 1,2,2-trimethyltrimethylene group, a 1-ethyl-l-methyltrimethylene group, a 2-ethyl-2-methyltrimethylene group, a 1-ethyl-2-methyltrimethylene group, a 2-ethyl-l-methyltrimethylene group, a heptylene group, an octylene group, a nonylene group, and a decylene group.

Examples of the substituent that Z may have include a halogen atom, an alkoxy group having from 1 to 5 carbon atoms, and an acyl group having from 2 to 5 carbon atoms. In a case in which Z have the substituent, the term “a number of carbon atoms” of the bivalent saturated hydrocarbon group represented by Z means a number which does not include a number of carbon atoms of the substituent, and the same applies below.

The bivalent group represented by Formula (IV) may be the following Formula (IV-1).

The bivalent group represented by Formula (V-1) may be the following Formula (VI-1).

The bivalent group represented by Formula (V-2) may be the following Formula (VI-2).

The bivalent group represented by Formula (V-3) may be the following Formula (VI-3).

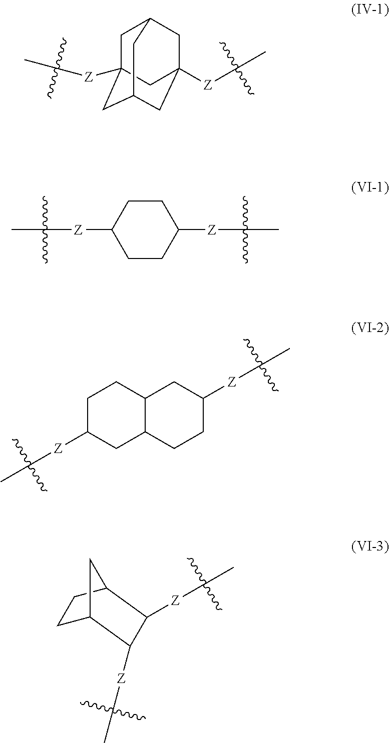

Details of Z in Formula (IV-1), (VI-1), (VI-2) and (VI-3) are the same as Z in Formula (IV), (V-1), (V-2) and (V-3).

Y may be a polyketone containing both of a structural unit represented by Formula (I) including Formula (IV) and a structural unit represented by Formula (I) including at least one selected from the group consisting of Formulae (V-1) to (V-3). In a case in which both of the group of Formula (IV) and at least one group selected from the group consisting of Formulae (V-1) to (V-3) are included, a mass ratio ((IV):(V-1) to (V-3)) of a content of Formula (IV) to a total content of Formulae (V-1) to (V-3) is not particularly limited. From the viewpoint of heat resistance and membrane formation properties, the mass ratio is preferably from 5:95 to 95:5, and more preferably from 5:95 to 90:10.

From the viewpoint of maintaining heat resistance, a weight average molecular weight (Mw) of the specific polyketone is preferably 500 or more in standard GPC (gel permeation chromatography) in terms of polystyrene, and from the viewpoint of higher heat resistance, the weight average molecular weight is more preferably from 10,000 to 1,000,000. In a case in which higher heat resistance is demanded, the weight average molecular weight (Mw) is even more preferably from 20,000 to 1,000,000. The weight average molecular weight (Mw) of the specific polyketone means a value measured by the method described in Examples.

The specific polyketone may be used singly or in combination of two or more kinds thereof.

The polyketone may contain a polyketone other than the specific polyketone. Hereinafter, also collectively referred to as “polyketone” that means the specific polyketone and the polyketone other than the specific polyketone. From the viewpoint of heat resistance and transparency of a membrane, a content of the specific polyketone in a total amount of the polyketone is preferably 50% by mass or more, more preferably 60% by mass or more, and even more preferably 70% by mass or more.

From the viewpoint of transparency of the membrane, a total content of the polyketone is preferably from 30 parts by mass to 90 parts by mass, and more preferably from 40 parts by mass to 80 parts by mass, based on 100 parts by mass of a total amount of the polyketone and an inorganic particle.

(Inorganic Particle)

Examples of the inorganic particles include silica, alumina, natural mica, synthetic mica, talc, calcium oxide, calcium carbonate, zirconium oxide, titanium oxide, antimony oxide, barium titanate, kaolin, bentonite, diatomaceous earth, boron nitride, aluminum nitride, silicon carbide, zinc oxide, cerium oxide, cesium oxide, magnesium oxide, calcium hydroxide, magnesium hydroxide, aluminum hydroxide, and graphite particles. Silica particles are preferably used from the viewpoint of transparency.

Inorganic particle may be used singly, or in combination of two or more kinds thereof.

A shape of the inorganic particle is not particularly limited, and preferably spherical from the viewpoint of transparency of the polyketone composition.

Such inorganic particles can be produced by, for example, any of known methods such as a flame hydrolysis method, a flame pyrolysis method, and a plasma method described in International Publication No. WO 96/31572. Such inorganic particles which can be preferably used are nanodisperse sols of stabilized colloidal inorganic particles, and commercial products such as colloidal silica manufactured by Admatechs, TiO₂ sols manufactured by Merck KGaA, SiO₂, ZrO₂, Al₂O₃ and Sb₂O₃ sols manufactured by Nissan Chemical Corporation, and silica (product name, AEROSIL) manufactured by NIPPON AEROSIL CO., LTD. are available.

The inorganic particles may be surface-modified. The surface modification of the inorganic particles can be performed with any known surface modifier. Such a surface modifier which can be used is, for example, a compound that can interact with a functional group present on the surfaces of the inorganic particles, for example, can be covalently bound to the functional group or can be taken with the functional group to form a complex, and a compound that can interact with a polymer matrix. Such a surface modifier which can be used is, for example, a compound having a functional group such as a carboxy group, a (primary, secondary, or tertiary) amino group, a quaternary ammonium group, a carbonyl group, a glycidyl group, a vinyl group, a (meth)acryloxy group, or a mercapto group. A preferable surface modifier is usually one which is in the form of a liquid under normal temperature and pressure conditions.

Examples of the surface modifier include a saturated or unsaturated mono or polycarboxylic acid compound (preferably, monocarboxylic acid compound) having from 1 to 12 carbon atoms, such as formic acid, acetic acid, propionic acid, butyric acid, pentanoic acid, hexanoic acid, acrylic acid, methacrylic acid, crotonic acid, citric acid, adipic acid, succinic acid, glutaric acid, oxalic acid, maleic acid, or fumaric acid; an ester compound thereof (preferably, an alkyl ester compound having from 1 to 4 carbon atoms, such as methyl methacrylate); an amide compound; a P-dicarbonyl compound such as acetylacetone, 2,4-hexanedione, 3,5-heptanedione, acetoacetic acid, or an alkyl acetoacetic acid compound having from 1 to 4 carbon atoms; and a silane coupling agent.

An average particle diameter of the inorganic particles is from 10 nm to 200 nm, preferably from 10 nm to 150 nm, and more preferably from 10 nm to 100 nm. In a case in which the average particle diameter of the inorganic particles is 10 nm or more, there is a tendency that a desired surface hardness can be easily obtained. In a case in which the average particle diameter of the inorganic particles is 200 nm or less, there is a tendency that a rising of haze can be restricted. Inorganic particles having an average particle diameter of less than 10 nm are difficult to produce and are hardly available in terms of dispersion stability.

In the present disclosures, the average particle diameter of the inorganic particles is defined as a value obtained by measurement after membrane formation, according to a method described in Examples.

A content of the inorganic particle is 10 parts by mass to 70 parts by mass, and preferably 20 part by mass to 60 parts by mass, based on 100 parts by mass of a total amount of the polyketone and an inorganic particle. In a case in which the content of the inorganic particle is 10 parts by mass or more, there is a tendency that a surface hardness is effective improved. In a case in which the content of the inorganic particle is 70 parts by mass or less, there is a tendency that a transparency of a polyketone membrane is excellent, a rising of haze of the polyketone membrane can be restricted, and toughness of the polyketone membrabe is is excellent.

In a case in which nanodisperse sols of stabilized colloidal inorganic particles are used for the inorganic particles, a dispersion liquid including the inorganic particles may be used as it is.

(Solvent)

The polyketone composition may further include a solvent. The solvent is not particularly limited as long as the solvent dissolves or disperses respective components, and examples thereof include y-butyrolactone, ethyl lactate, propylene glycol monomethyl ether acetate, butyl acetate, benzyl acetate, n-butyl acetate, ethoxyethyl propionate, 3-methyl methoxypropionate, N-methyl-2-pyrrolidone, N-cyclohexyl-2-pyrrolidone, N,N-dimethylformamide, N,N-dimethylacetamide, hexamethylphosphorylamide, tetramethylene sulfone, diethyl ketone, diisobutyl ketone, methyl amyl ketone, cyclopentanone, cyclohexanone, propylene glycol monomethyl ether, propylene glycol monopropyl ether, propylene glycol monobutyl ether, dipropylene glycol monomethyl ether, xylene, mesitylene, ethylbenzene, propylbenzene, cumene, diisopropylbenzene, hexylbenzene, anisole, diglyme, dimethylsulfoxide, chloroform, dichloromethane, dichloroethane, and chlorobenzene. The solvent also encompasses the solvent of the dispersion liquid described with respect to the inorganic particles. These solvents may be used singly, or may be used in combination of two or more kinds thereof.

In a case in which the polyketone composition contains solvent, a content of the solvent is preferably from 5 parts by mass to 95 parts by mass, and more preferably from 10 parts by mass to 90 parts by mass based on a total amount of 100 parts by mass of the polyketone, the inorganic particle and the solvent.

(Other Additives)

The polyketone composition may further contain other additives. Examples of the other additives include adhesion aids, surfactants, leveling agents, antioxidants, and UV deterioration inhibitors.

<Polyketone Membrene>

A polyketone membrane in the present embodiment is formed from the polyketone composition in the present embodiment.

A method of producing the polyketone membrane in the present embodiment is not particularly limited. For example, the polyketone composition in the present embodiment containing a solvent is applied to a surface of at least a part of a substrate to form a composition layer, and if necessary, the layer is dried to remove the solvent from the composition layer, whereby a polyketone membrane in the present embodiment can be produced. The obtained polyketone membrane can be used as a substrate with polyketone membrane, in which the substrate remains to be attached, or the polyketone membrane can also be used after being peeled off from the substrate.

The method of applying the polyketone composition to a substrate is not particularly limited, and examples thereof include dipping, spraying, screen printing, bar coating, and spin coating.

In a case in which the polyketone composition contains the solvent, the composition may be dried. The drying method is not particularly limited, and examples thereof include a method of heat treatment using an apparatus such as a hot plate or an oven, and a method of natural drying. The conditions for the heat treatment for drying are not particularly limited as long as the solvent in the polyketone composition is sufficiently volatilized, and the conditions are usually about from 50° C. to 150° C. for about from 1 minute to 90 minutes.

If necessary, the dried polyketone membrane may be further heat-treated in order to completely remove a residual solvent. The method of heat treatment is not particularly limited, and the heat treatment can be carried out using an oven such as a box dryer, a hot air conveyor dryer, a quartz tube furnace, a hot plate, a rapid thermal annealing, a vertical diffusion furnace, an infrared curing oven, an electron beam curing oven, a microwave curing oven, or a vacuum dryer. An atmospheric conditions in the heat treatment are not particularly limited, and examples thereof include atmospheric air and an inert atmosphere such as nitrogen. Conditions for carrying out the heat treatment are not particularly limited, and the conditions are about from 150° C. to 250° C. for about from 1 minute to 90 minutes. Further heat treatment tends to increase a density of the polyketone membrane to be obtained.

In a case in which the polyketone composition configures a membrane having a thickness of 10 μm, haze is preferably less than 1%. In a case in which the polyketone composition configures a membrane, a transmittance of visible light with a wavelength of 400 nm is 85% or more in terms of a 1 μm film thickness equivalent.

<Substrate with Polyketone Membrane>

A substrate with a polyketone membrane in the present embodiment includes: a substrate; and a polyketone membrane in the present embodiment, which is provided on or above at least one portion of a surface of the substrate. A substrate with a polyketone membrane in the present embodiment may have a polyketone membrane on or above one surface of the substrate, or may have a polyketone membrane on or above each of both surfaces of the substrate. Such a polyketone membrane formed on or above the substrate may have a single layer structure of one layer or a multilayer structure of two or more layers layered.

A type of the substrate is not particularly limited. Examples can include an inorganic substrate such as a glass substrate, a semiconductor substrate, a metal oxide insulator substrate (for example, a titanium oxide substrate or a silicon oxide substrate), and a silicon nitride substrate, and a substrate of a resin such as triacetylcellulose, polyimide, polycarbonate, an acrylic resin, and a cycloolefin resin. The substrate may be transparent or non-transparent. A shape of substrate is not particularly limited, and examples include a plate or film shape.

<Optical Element and Image Display Device>

Each of an optical element and an image display device in the present embodiment has the polyketone membrane or the substrate with a polyketone membrane in the present embodiment. In a case in which the substrate is a transparent substrate, the substrate can be suitably used for an optical element.

The optical element and the image display device can be obtained, for example, by adhering the substrate with a polyketone membrane to an application site of an LCD (liquid crystal display), an ELD (electroluminescence display) or the like via an gluing agent, an adhesive agent or the like.

A variety of optical elements such as a polarizing plate using the polyketone membrane or the substrate with a polyketone membrane can be preferably used for a variety of image display devices such as a liquid crystal display device. The image display device may have the same configuration as that of a conventional image display device except that the polyketone membrane or the substrate with a polyketone membrane in the present embodiment is used. In a case in which the image display device is a liquid crystal display device, the device can be produced by appropriately assembling an optical element such as a liquid crystal cell or a polarizing plate, and, if necessary, a variety of components such as a lighting system (backlight or the like), and incorporating a driving circuit. The liquid crystal cell is not particularly limited, and a variety of types such as a TN type, an STN type, or a π type can be used.

Applications of the image display device are not particularly limited, and examples thereof include office equipment such as a desktop personal computer, a laptop computer, or a copy machine; a mobile device such as a mobile phone, a watch, a digital camera, a personal digital assistant (PDA), or a portable game machine; a household electric appliance such as a video camera, a television, or a microwave oven; in-vehicle equipment such as a back monitor, a car navigation system monitor, or a car audio; exhibition equipment such as a monitor for information for commercial store; security equipment such as a surveillance monitor; nursing care equipment such as a nursing care monitor; and medical equipment such as a medical monitor.

<Covered Member>

The covered member in the present embodiment includes: a member; and a covered membrane that is formed from the polyketone composition, and that is provided on or above at least one portion of a surface of the member.

The member to be covered is not particularly limited, and examples thereof include office automation equipment such as a desktop personal computer, a notebook computer, or a copy machine, a mobile device such as a mobile phone, a digital camera, a personal digital assistant (PDA) or a portable game machine, a video camera, a television, various displays, window glass, car glass, and a camera lens.

The method of producing the covered member using the polyketone composition is not particularly limited, and for example, a covering may be conducted by adhering the polyketone membrane to a member to be covered by a method such as lamination, or a covered member may be formed by applying a liquid polyketone composition to a member to be coated and then drying thereof.

<Molded Article>

The molded article in the present embodiment is formed from the polyketone composition in the present embodiment. The method of producing the molded article is not particularly limited, and a method known in the art may be used. Examples of such a method include an extrusion molding method, an injection molding method, a calender molding method, a blow molding method, a fiber reinforced plastic (FRP) molding method, a laminating molding method, a casting method, a powder molding method, a solution casting method, a vacuum forming method, an air-pressure forming method, an extrusion composite molding method, a stretch molding method, and a foam molding method.

Various additives may be added to the molded article in the present embodiment, if necessary, for imparting desired functions, improving properties, improving moldability, or the like. Examples of the additive include a sliding agent (such as polytetrafluoroethylene particles), a light diffusing agent (such as acrylic crosslinked particles, silicone crosslinked particles, ultrathin glass flakes, or calcium carbonate particles), a fluorescent dye, an inorganic fluorescent substance (such as a fluorescent substance having aluminate as a mother crystal), an antistatic agent, a crystal nucleating agent, an inorganic or organic antimicrobial agent, a photocatalyst-based antifouling agent (such as titanium oxide particles, or zinc oxide particles), a crosslinking agent, a curing agent, a reaction accelerator, an infrared absorbing agent (such as heat absorbing agent), and a photochromic agent.

### EXAMPLES

The present invention will be described in more details below by way of Examples and Comparative Examples, provided that the present invention be not restricted in any way by the following Examples.

<Molecular Weight Measurement of Polyketone>

A molecular weight (weight average molecular weight and number average molecular weight) of a polyketone was measured by a gel permeation chromatography (GPC) method using tetrahydrofuran as an eluent, and was determined based on standard polystyrene. Details are as follows.
Device name: Ecosec HLC-8320GPC (TOSOH CORPORATION)
Column: TSK gel Supermultipore HZ-M (TOSOH CORPORATION)
Detector: UV detector and RI detector in combination
Flow rate: 0.4 ml/minutes

<Synthesis of Polyketone>

### (Synthesis Example 1) Synthesis of Polyketone PK-1

To a flask containing 10 mmol of 2,2′-dimethoxybiphenyl and 10 mmol of 1,3-adamantane dicarboxylic acid as a monomer, 30 ml of a mixed solution of diphosphorus pentoxide and methanesulfonic acid (mass ratio 1: 10) was added, and then the mixture was allowed to react at 60° C. with stirring. After the reaction, the contents were poured into 500 ml of methanol, and a precipitate formed was collected by filtration. The obtained solid was washed with distilled water and methanol, and then dried to obtain polyketone PK-1.

The weight average molecular weight of the polyketone PK-1 was 20,000 and the number average molecular weight thereof was 8,000. The weight average molecular weight and the number average molecular weight are values measured and calculated by the method in described above. The same applies to the weight average molecular weight and to the number average molecular weight of the following polyketones PK-2 to polyketone PK-11.

### (Synthesis Example 2) Synthesis of Polyketone PK-2

Polyketone PK-2 was obtained by the same manner as described in Example 1, except that 10 mmol of 2,2′-dimethoxybiphenyl and 10 mmol of 1,4-cyclohexane dicarboxylic acid (a mixture of cis and trans, sis: trans (mol ratio)=7:3) as a monomer were used. A weight average molecular weight of the polyketone PK-2 was 25,000 and a number average molecular weight thereof was 9,000.

### (Synthesis Example 3) Synthesis of Polyketone PK-3

Polyketone PK-3 was obtained by the same manner as described in Example 1, except that 10 mmol of 2,2′-dimethoxybiphenyl and 10 mmol of 1,3-adamantane diacetic acid as a monomer were used. A weight average molecular weight of the polyketone PK-3 was 42,000 and a number average molecular weight thereof was 12,000.

### (Synthesis Example 4) Synthesis of Polyketone PK-4

Polyketone PK-4 was obtained by the same manner as described in Example 1, except that 10 mmol of 2,2′-dimethoxybiphenyl, 5 mmol of 1,3-adamantane dicarboxylic acid, and 5 mmol of dodecanedioic acid as a monomer were used. A weight average molecular weight of the polyketone PK-4 was 36,000 and a number average molecular weight thereof was 13,000.

### (Synthesis Example 5) Synthesis of Polyketone PK-5

Polyketone PK-5 was obtained by the same manner as described in Example 1, except that 10 mmol of 2,2′-dimethoxybiphenyl, 5 mmol of 1,3-adamantane diacetic acid, and 5 mmol of dodecanedioic acid as a monomer were used. A weight average molecular weight of the polyketone PK-5 was 39,000 and a number average molecular weight thereof was 12,000.

### (Synthesis Example 6) Synthesis of Polyketone PK-6

Polyketone PK-6 was obtained by the same manner as described in Example 1, except that 10 mmol of 2,2′-dimethoxybiphenyl, 5 mmol of 1,3-adamantane diacetic acid, and 5 mmol of hexanedioic acid as a monomer were used. A weight average molecular weight of the polyketone PK-6 was 39,000 and a number average molecular weight thereof was 12,000.

### (Synthesis Example 7) Synthesis of Polyketone PK-7

Polyketone PK-7 was obtained by the same manner as described in Example 1, except that 10 mmol of 2,2′-dimethoxybiphenyl, 5 mmol of 1,3-adamantane diacetic acid, and 5 mmol of cis-1,4-cyclohexane dicarboxylic acid as a monomer were used. A weight average molecular weight of the polyketone PK-7 was 45,000 and a number average molecular weight thereof was 11,000.

### (Synthesis Example 8) Synthesis of Polyketone PK-8

Polyketone PK-8 was obtained by the same manner as described in Example 1, except that 10 mmol of 2,2′-dimethoxybiphenyl, 5 mmol of 1,3-adamantane diacetic acid, and 5 mmol of decalin-2,6-dicarboxylic acid as a monomer were used. A weight average molecular weight of the polyketone PK-8 was 33,000 and a number average molecular weight was 10,000.

### (Synthesis Example 9) Synthesis of Polyketone PK-9

Polyketone PK-9 was obtained by the same manner as described in Example 1, except that 10 mmol of 2,2′-dimethoxybiphenyl, 5 mmol of 1,3-adamantane diacetic acid, and 5 mmol of norbornane dicarboxylic acid (a mixture of 2,4- and 2,5-) as a monomer were used. A weight average molecular weight of the polyketone PK-9 was 27,000 and a number average molecular weight thereof was 9,200.

### (Synthesis Example 10) Synthesis of Polyketone PK-10

Polyketone PK-10 was obtained by the same manner as described in Example 1, except that 10 mmol of 2,2′-bis(2-methoxyphenyl)propane, 5 mmol of 1,3-adamantane diacetic acid, and 5 mmol of 1,4-cyclohexane dicarboxylic acid (a mixture of cis and trans, sis:trans (mol ratio) =7:3) as a monomer were used. A weight average molecular weight of the polyketone PK-10 was 28,000 and a number average molecular weight thereof was 8,300.

### (Synthesis Example 11) Synthesis of Polyketone PK-11

Polyketone PK-11 was obtained by the same manner as described in Example 1, except that 10 mmol of diphenylether, 5 mmol of 1,3-adamantane diacetic acid, and 5 mmol of 1,4-cyclohexane dicarboxylic acid (a mixture of cis and trans, sis: trans (mol ratio) =7:3) as a monomer were used. A weight average molecular weight of the polyketone PK-11 was 27,000 and a number average molecular weight was 8,000.

<Preparation of Polyketone Composition>

### Example 1

After 0.90 g of the polyketone (PK-1) was dissolved in 3.30 g of N-methyl-2-pyrrolidone (hereinafter, referred to as “NMP”), 0.33 g (solid content 0.1 g) of a dispersion liquid of silica (particle A) in cyclohexanone (CHO-ST-M manufactured by Nissan Chemical Corporation) was added thereto, and the resultant was stirred and subjected to filtration with a membrane filter (pore diameter 5 μm) made of polytetrafluoroethylene, thereby obtaining a polyketone composition.

### Examples 2 to 15 and Comparative Examples 1 to 4

Each polyketone composition was obtained by the same method as in Example 1 expect that a formulation was changed as shown in Table 1. Each numerical value in Table 1 is represented by part(s) by mass of each component based on 100 parts by mass of a total amount of the polyketone and the inorganic particles. Particle B (silica) used was SC1050-SXT manufactured by Admatechs. Particle C (titanium oxide) used was Aldrich 637254 manufactured by Sigma-Aldrich. Particle D (silica) used was SO-E2 manufactured by Admatechs.

TABLE 1

| | | Example | Example | Example | Example | Example | Example | Example | Example | Example | Example |
|---|---|---|---|---|---|---|---|---|---|---|---|
| Item | | 1 | 2 | 3 | 4 | 5 | 6 | 7 | 8 | 9 | 10 |
| Polyketone | PK1 | 90 | 70 | 40 | 70 | 70 | — | — | — | — | — |
| | PK2 | — | — | — | — | — | 70 | — | — | — | — |
| | PK3 | — | — | — | — | — | — | 70 | — | — | — |
| | PK4 | — | — | — | — | — | — | — | 70 | — | — |
| | PK5 | — | — | — | — | — | — | — | — | 70 | — |
| | PK6 | — | — | — | — | — | — | — | — | — | 70 |
| | PK7 | — | — | — | — | — | — | — | — | — | — |
| | PK8 | — | — | — | — | — | — | — | — | — | — |
| | PK9 | — | — | — | — | — | — | — | — | — | — |
| | PK10 | — | — | — | — | — | — | — | — | — | — |
| | PK11 | — | — | — | — | — | — | — | — | — | — |
| Inorganic | particle A | 10 | 30 | 60 | — | — | 30 | 30 | 30 | 30 | 30 |
| particle | particle B | — | — | — | 30 | — | — | — | — | — | — |
| | particle C | — | — | — | — | 30 | — | — | — | — | — |
| | | | Example | Example | Example | Example | Example | Comparative | Comparative | Comparative | Comparative |
| | Item | | 11 | 12 | 13 | 14 | 15 | Example 1 | Example 2 | Example 3 | Example 4 |
| | Polyketone | PK1 | — | — | — | — | — | 100 | 95 | 20 | 70 |
| | | PK2 | — | — | — | — | — | — | — | — | — |
| | | PK3 | — | — | — | — | — | — | — | — | — |
| | | PK4 | — | — | — | — | — | — | — | — | — |
| | | PK5 | — | — | — | — | — | — | — | — | — |
| | | PK6 | — | — | — | — | — | — | — | — | — |
| | | PK7 | 70 | — | — | — | — | — | — | — | — |
| | | PK8 | — | 70 | — | — | — | — | — | — | — |
| | | PK9 | — | — | 70 | — | — | — | — | — | — |
| | | PK10 | — | — | — | 70 | — | — | — | — | — |
| | | PK11 | — | — | — | — | 70 | — | — | — | — |
| | Inorganic | particle A | 30 | 30 | 30 | 30 | 30 | — | 5 | 80 | — |
| | particle | particle B | — | — | — | — | — | — | — | — | — |
| | | particle C | — | — | — | — | — | — | — | — | — |
| | | particle C | — | — | — | — | — | — | — | — | 30 |

<Production and Evaluation of Evaluation Sample>

The obtained polyketone composition was used to produce a membrane according to the following method, and an evaluation sample described below was prepared, and evaluated as follows.

(1) Measurement of Average Particle Diameter

The obtained polyketone composition was applied on a glass substrate by a bar coating method and dried on a hot plate heated to 120° C. for 3 minutes, thereby producing a glass substrate with a polyketone membrane having a thickness of 10 The glass substrate with a polyketone membrane was heat-treated at 200° C. for 1 hour in an inert gas oven purged with nitrogen, and then cut with a diamond cutter, and a cut surface (a cross section of the membrane) was observed with a scanning electron microscope (XL-30 manufactured by Koninklijke Philips N.V). A major diameter of each of 50 primary particles as inorganic particles in the obtained observation image was measured, and an average value thereof was defined as an average particle diameter.

The major diameter here means a distance between two parallel lines away from each other at the longest interval, among combinations of two parallel lines in contact with an outer circumference of a particle appearing at the cut surface, the combinations being selected so that the two lines thereof sandwich the particle.

(2) Measurement of Haze

The obtained polyketone composition was applied on a glass substrate by a bar coating method and dried on a hot plate heated to 120° C., for 3 minutes, thereby producing a glass substrate with a polyketone membrane having a thickness of 10 The glass substrate with a polyketone membrane was heat-treated at 200° C. for 1 hour in an inert gas oven purged with nitrogen, and then the haze was measured using a haze meter (NDH 2000 manufactured by NIPPON DENSHOKU INDUSTRIES Co., Ltd.), using a glass substrate with no polyketone membrane as a blank. The obtained haze is shown in Table 2.

(3) Evaluation of Transparency

The obtained polyketone composition was applied on a glass substrate by a bar coating method and dried on a hot plate heated to 120° C. for 3 minutes, thereby producing a glass substrate with a polyketone membrane having a thickness of 10 μm. The glass substrate with a polyketone membrane was heat-treated at 200° C. for 1 hour in an inert gas oven purged with nitrogen, and then, the transmittance at a wavelength of 400 nm was measured by ultraviolet-visible absorption spectrum method using a UV-visible spectrophotometer (“U-3310 Spectrophotometer” Hitachi High-Tech Co., Ltd.). Table 2 shows the transmittance (%) in terms of a 1 μm film thickness equivalent, using a glass substrate without the polyketone membrane as a reference. The thickness was taken as an arithmetic mean value of values measured at three points using a stylus profilometer (“Dektak 3ST”, ULVAC, Inc. (Veeco)).

(4) Evaluation of Heat Resistance

The obtained polyketone composition was applied on a polyimide (Kapton) film by a bar coating method and dried on a hot plate heated to 120° C. for 3 minutes, thereby producing a polyimide substrate with a polyketone membrane having a thickness of 10 μm. The polyketone membrane was peeled off from the polyimide substrate and heat-treated at 200° C. for 1 hour in an inert gas oven purged with nitrogen. Thereafter, the glass transition temperature of the polyketone membrane was measured by a dynamic viscoflexibility measurement method (tensile mode) using a dynamic viscoflexibility measuring device (“RSA-II” Rheometrics Inc.). The obtained values (° C.) of the glass transition temperature are shown in Table 2.

(5) Evaluation of Pencil Hardness

The glass substrate with a polyketone membrane was produced by the same method as the Evaluation of transparency, and the test of a pencil hardness was conducted according to JIS K 5600-5-4: 1999. The test results are shown in Table 2.

(6) Measurement of Coefficient of Thermal Expansion (CTE)

A polyketone membrane was produced by the same method as in Evaluation of heat resistance, and subjected to measurement with a thermomechanical analyzer (TMA/SS 6000 manufactured by Seiko Instruments Inc.) in conditions of a distance between chucks of 15 mm, a measurement temperature range of from 20° C. to 300° C., a rate of temperature rise of 5° C./min, and a tensile load of 0.5 MPa with respect to a cross sectional area of the polyketone membrane, and an average coefficient of thermal expansion in a temperature range of from 50° C. to 200° C. was calculated. The test results are shown in Table 2.

TABLE 2

| | Average | | | | | |
|---|---|---|---|---|---|---|
| | particle | | | | Pencil | |
| | diameter | Haze | Transmittance | Tg | Hardbness | CTE |
| Item | (nm) | (%) | (%) | (° C.) | — | (ppm/° C.) |
| Example 1 | 20 | 0.1 | 96 | 186 | 2H | 48 |
| Example 2 | 20 | 0.3 | 96 | 191 | 2H | 46 |
| Example 3 | 20 | 0.5 | 95 | 199 | 4H | 38 |
| Example 4 | 200 | 0.5 | 91 | 188 | 3H | 47 |
| Example 5 | 25 | 0.3 | 93 | 188 | 2H | 47 |
| Example 6 | 20 | 0.2 | 98 | 220 | 4H | 35 |
| Example 7 | 20 | 0.2 | 98 | 185 | 2H | 48 |
| Example 8 | 20 | 0.1 | 98 | 180 | 2H | 50 |
| Example 9 | 20 | 0.2 | 98 | 182 | 2H | 50 |
| Example 10 | 20 | 0.2 | 98 | 184 | 2H | 49 |
| Example 11 | 20 | 0.1 | 98 | 215 | 4H | 36 |
| Example 12 | 20 | 0.2 | 98 | 230 | 5H | 33 |
| Example 13 | 20 | 0.2 | 98 | 228 | 4H | 35 |
| Example 14 | 20 | 0.2 | 98 | 221 | 4H | 36 |
| Example 15 | 20 | 0.2 | 98 | 195 | 3H | 44 |
| Comparative | — | 0.1 | 98 | 183 | HB | 70 |
| Example 1 | | | | | | |
| Comparative | 20 | 0.1 | 98 | 183 | HB | 65 |
| Example 2 | | | | | | |
| Comparative | 20 | 1.1 | 95 | Not formable | 4H | Not formable |
| Example 3 | | | | in membrane | | in membrane |
| | | | | shape | | shape |
| Comparative | 500 | 2 | 86 | 195 | 3H | 45 |
| Example 4 | | | | | | |

It is found that the membranes formed from the polyketone compositions in Examples exhibits a high surface hardness and a low coefficient of thermal expansion while maintaining transparency and heat resistance.

The entire contents of the present disclosures by Japanese Patent Application No. 2017-15424 filed on Jan. 31, 2017 are incorporated herein by reference.

All the literature, patent application, and technical standards cited herein are also herein incorporated to the same extent as provided for specifically and severally with respect to an individual literature, patent application, and technical standard to the effect that the same should be so incorporated by reference.

1. A polyketone composition comprising:
a polyketone containing a structural unit represented by the following Formula (I); and
inorganic particles,
wherein a content of the inorganic particle is from 10 parts by mass to 70 parts by mass, based on 100 parts by mass of a total amount of the polyketone and the inorganic particles, and an average particle diameter of the inorganic particles is from 10 nm to 200 nm: 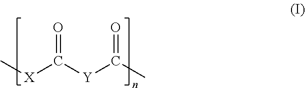
wherein, in Formula (I), each X independently represents a bivalent group that has from 1 to 50 carbon atoms and that may have a substituent group, each Y independently represents a bivalent hydrocarbon group that has from 1 to 30 carbon atoms and that may have a substituent group, and n represents an integer from 1 to 1,500.

2. The polyketone composition according to claim 1, wherein, in a case in which the polyketone composition configures a membrane having a thickness of 10 μm, haze is less than 1%.

3. The polyketone composition according to claim 1, wherein, in a case in which the polyketone composition configures a membrane, a transmittance of visible light with a wavelength of 400 nm is 85% or more in terms of a 1 μm film thickness equivalent.

4. The polyketone composition according to claim 1, wherein each X independently comprises a bivalent group that has from 6 to 50 carbon atoms and that has an aromatic ring.

5. The polyketone composition according to claim 1, wherein each X independently comprises at least one selected from the group consisting of the following Formulae (II-1) to (II-3): 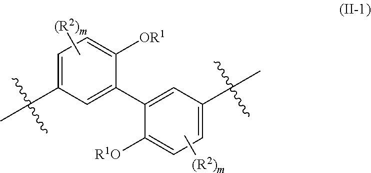
wherein, in Formula (II-1), each R¹ independently represents a hydrogen atom or a hydrocarbon group that has from 1 to 30 carbon atoms and that may have a substituent group, each R² independently represents a hydrocarbon group that has from 1 to 30 carbon atoms and that may have a substituent, and each m independently represents an integer from 0 to 3, 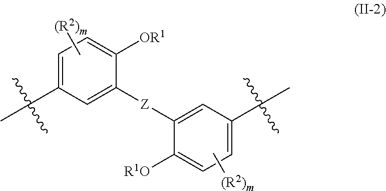
wherein, in Formula (II-2), each R¹ independently represents a hydrogen atom or a hydrocarbon group that has from 1 to 30 carbon atoms and that may have a substituent group, each R² independently represents a hydrocarbon group that has from 1 to 30 carbon atoms and that may have a substituent group, each m independently represents an integer from 0 to 3, and Z represents an oxygen atom or a bivalent group represented by the following formulae (III-1) to (III-7): 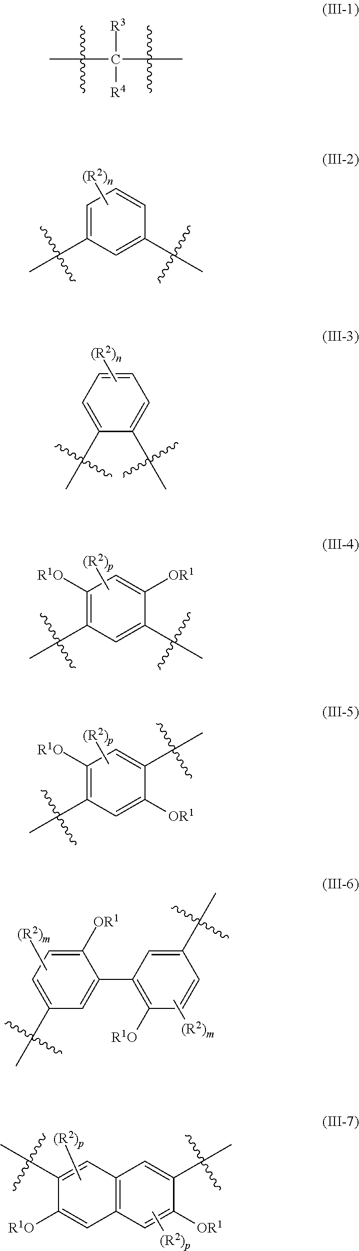
wherein, in Formulae (III-1) to (III-7), each R¹ independently represents a hydrogen atom or a hydrocarbon group that has from 1 to 30 carbon atoms and that may have a substituent group, each R² independently represents a hydrocarbon group that has from 1 to 30 carbon atoms and that may have a substituent group, each of R³ and R⁴ independently represents a hydrogen atom or a hydrocarbon group that has from 1 to 30 carbon atoms and that may have a substituent group, each m independently represents an integer from 0 to 3, each n independently represents an integer from 0 to 4, and each p independently represents an integer from 0 to 2, and 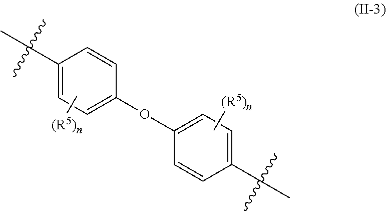
wherein, in Formula (II-3), each R⁵ represents a hydrocarbon group that has from 1 to 30 carbon atoms and that may have a substituent, and each n independently represents an integer from 0 to 4.

6. The polyketone composition according to claim 1, wherein, in Formula (I), Y comprises a bivalent saturated hydrocarbon group.

7. The polyketone composition according to claim 6, wherein, in Formula (I), Y comprises a bivalent saturated alicyclic hydrocarbon group.

8. The polyketone composition according to claim 1, wherein, in Formula (I), Y has from 6 to 30 carbon atoms.

9. The polyketone composition according to claim 1, wherein the inorganic particles are silica particles.

10. The polyketone composition according to claim 1, further comprising a solvent.

11. A polyketone membrane that is formed from the polyketone composition according to claim 1.

12. A substrate with a polyketone membrane, comprising:
a substrate; and
a polyketone membrane according to claim 11, that is provided on or above at least one portion of a surface of the substrate.

13. An optical element comprising the polyketone membrane according to claim 11.

14. An image display device comprising the polyketone membrane according to claim 11.

15. A covered member comprising:
a member; and
a covering membrane that is formed from the polyketone composition according to claim 1, and that is provided on or above at least one portion of a surface of the member.

16. A molded article that is formed from the polyketone composition according to claim 1.

17. An optical element comprising the substrate with a polyketone membrane according to claim 12.

18. An image display device comprising the substrate with a polyketone membrane according to claim 12.
